(19) United States
(12) Patent Application Publication
(10) Pub. No.: US 2011/0109049 A1
(43) Pub. Date: May 12, 2011

(54) SEALING ELEMENT FOR SEALING FLANGE SURFACES IN INTERNAL COMBUSTION ENGINES

(76) Inventors: Rolf Prehn, Wipperfurth (DE); Schneider Matthias, Burscheid (DE)

(21) Appl. No.: 13/000,564

(22) PCT Filed: Jun. 19, 2009
(86) PCT No.: PCT/DE09/00843

§ 371 Date: Dec. 21, 2010

(30) Foreign Application Priority Data
Jun. 21, 2008 (DE) 10 2008 029 542.6

(51) Int. Cl. F02F 11/00

(52) U.S. Cl. 277/595

(57) ABSTRACT

The invention relates to a sealing element for sealing flange surfaces in internal combustion engines, consisting of at least one annular metallic profiled body. Said sealing element is characterised in that the profiled body consists of a wire and comprises at least one central area and at least one flexible area. The material thickness of the wire in the central area is greater than the thickness of the wire in the respective flexible area.

The invention relates to a sealing element for the sealing of flange surfaces in the case of internal combustion engines, consisting of at least one ring-shaped metallic profile body.

It is known, in the case of metallic cylinder-head gaskets, which consist of several layers, to connect the different layers together with suitable joining processes (for example, clinching, welding, riveting). These layers can have seams or other sealing elements in the form of polymer gaskets, in order to seal off fluids or gases.

Such sealing elements must, on the one hand, have adequate spring properties, in order to counterbalance static unevennesses as well as dynamic sealing-gap oscillations (during operation as a cylinder-head gasket). On the other hand, these gaskets must be rigid enough, in order not to give way to such an extent, that an inadequate tensioning force brings about a disruption of the sealing element.

It is also known to use profiled metal rings, in order to generate an adequate pre-stressing on the combustion chamber boundary of an internal combustion engine. The principle used thereby is to deform a metallic ring plastically in such a manner, that the sealing gap is sealed. However, the essential prerequisite for the operation of such a gasket seal is then, that no sealing-gap movement occurs, for a plastically deformed metal ring offers virtually no elastic properties, which could be used to counterbalance the sealing-gap oscillations.

A seal of a cylinder liner can be learned from GB 979,408, which is formed by a ring-shaped metallic profile body, which, seen via its radial wall thickness, has a uniform height and an essentially symmetrical cross-section profile. Between the cylinder head and the motor block, a cylinder-head gasket is arranged, which has a radial free space for the acceptance of this profile body. Due to the contour of the sealing element vaulted outwards, which rises above the axial construction height of the cylinder-head gasket, the profile body is elastically deformed during the bracing of the motor block and cylinder head within its groove receiving it in such a way, that during maximum deformation pressure the profile body with the exception of its lateral receiving areas still has a defined distance to the groove base of the receiving groove. The profile body is produced from a non-rusting steel and has at least sharp-edged transition regions on the groove base side from the respective radial end limit into the associated axial flank. At this juncture, the sharp-edged transition regions afford the adequately high surface pressure in the area of both sealing lines.

Through DE 12 53 950 a sealing ring for the sealing of cylinder covers in the case of internal combustion engines has been known, consisting of at least one layer of sheet metal, in which the layer is designed in the cross-section in the shape of a circular segment and the inner edge as well as the outer edge are arranged in a plane. Also, here the axial height of the sealing ring, seen via its entire radial wall thickness, is designed the same. Furthermore, in this prior art it is proposed, that the sealing ring consists of two sealing rings arranged inversely to each other, which touch one another along a central diameter.

The task which underlies the invention is to provide a novel sealing element for sealing flange surfaces in the case of internal combustion engines, which, on the one hand, has adequate spring-properties, in order to counterbalance static unevennesses of the respective sealing surface and, if necessary, dynamic sealing-gap oscillations. Furthermore, the sealing element must be rigid enough, in order not to give way to such an extent, that an inadequate tensioning force produces a disruption of the sealing element.

This task is solved in that the profile body consists of a wire and at least one core area and at least one bending area, in which the material thickness of the wire in the core area is designed greater than in the respective bending area.

Advantageous further developments of the subject matter of the invention can be learned from the sub-claims.

The subject matter of the invention is based on the technical embodiment of a bending beam. Through the application of forces or the bracing of such a geometry between two plates (for example, between a motor block and a cylinder head) the bending beam is loaded from above, approximately in the center and the force is supported by both support points on the outside of the rear side. Thus, on the one hand, the support points are exactly definable and, on the other hand, the power distribution between the support points is adjustable. Furthermore, the thickness of the bending beam correlates with the rigidity of the system and the spring-properties dedicated to the system (material selection).

Based on this principle several technical embodiments present themselves according to the present invention
the radial wall thickness of the wire is profiled in such a manner, that it corresponds approximately to the form of a banana;
the wire has such a profile, that the radial ends forming a notch in each case form two upper and two lower bending areas;
the wire has such a profile, that radially inwards or outwards a thickened core area is given and at the opposite end of the cross-section two bending areas are fowled, which rise above the axial height of the core area in the initial state.

It is particularly advantageous compared to the prior art, that at least the free radial ends of the respective bending area are provided for in rounded form. Thus, incisions, particularly in the case of dynamic sealing-gap oscillations, are avoided in the groove receiving the sealing element.

With the use of a banana-shaped geometry of the wire the profile has the maximum cross-section in the center. The cross-section (uniform or irregular) tapers towards both ends. This means the elastic ends bend during loading. Under total compression, as it can be adjusted in the case of a cylinder-head gasket, the center of the lower bend of the banana-shaped profile touches down on the respective flange surface, or rather the groove base, in such a manner that only this central area bears. A so-called stopper function is established by this active principle. Furthermore, an additional sealing line is defined by the stopper area. This additional sealing line is particularly advantageous for the sealing of comparably high pressures, since in contrast to the prior art with two sealing lines sharp-edged transition regions can be dispensed with.

This mode of action corresponding to the classical bending beam can also be transferred to other profiles, underlying the subject matter of the invention. The outer ends, forming bending areas, bend elastically, until under total compression again only the central area bears.

With the subject matter of the invention a spring element is thus combined with an integrated stopper element. The stopper height or the installation height thus results from the largest cross-section or the largest cross-sections, insofar as several sub-areas are designed as core areas. The spring behavior (and the sealing force) of such a wire profile define the arrangement of the elastic areas.

Through targeted dimensioning of the profile-wire geometry, for example, through FEM, the contour can be selected so that the sealing force in the installation point can be exactly adjusted. Thus, it can be ensured that both the static unevennesses of the respective flange surfaces and, if necessary, the dynamic sealing-gap oscillations can be counterbalanced.

If an additional micro-sealing should be required, the profile wire ring can also, for example, still be completely or only partially coated.

According to a further idea of the invention, it can prove to be advantageous to shape the wire profile asymmetrically. Thus, the power distribution (delay) on the motor block or on the cylinder gasket can be positively influenced.

The sealing element according to the present invention can be adjusted both in combination with a cylinder-head gasket as well as with a flat gasket or as an individual sealing element, for example, in the exhaust gas system of an internal combustion engine.

Depending on whether other sealing elements are to be combined with this wire-shaped media-sealing element, different requirements can arise for the profile-wire sealing ring according to the present invention. The following requirements are exemplarily conceivable:
additional (at last partial) coating for the micro-seal,
joining of the profile-wire sealing ring (it is also conceivable, that the sealing ring is not joined at the joint similarly as in the case of a piston ring, but rather remains thus),
design of at least one zone or an area, which is required for a joining process.

The profiled wire, according to a further idea of the invention, is produced from a spring steel, which advantageously has a yield strength of ≧600 MPa.

Here known austenitic or martensitic, rust-free or low-rust material present themselves.

It is also conceivable, that the wire consists of a non-stainless steel.

The person skilled in the art will select the suitable material depending on the application.

Generally, it can be said that all spring steels can be considered as materials for the profile wire, which involve elastic or resilient properties.

Austenitic chromium-nickel steels, martensitic chromium steels, bainitic or martensitic carbon steels or multi-phase steels are referred to here as exemplary. In the case of the use as a sealing element in an exhaust gas system reference is be made to nickel-base alloys.

The combination of the suitable material or possibly also the suitable materials, if necessary, including a hardening process and/or a heat treatment as well as the optimized geometry (wire cross-section) ensures the function of the sealing element according to the present invention depending on the installation location under all operating states.

Depending on the application, such as, for example, passenger car or commercial vehicle, diesel or gasoline-operated engine, supercharged (for example, turbo or compressor) or not, presumably a different geometrical form of the sealing element adjusted in each case can be most advantageous (depending on the combustion pressure and the combustion temperature different cross-sections come into consideration).

With the help of the geometry, the thickness of the respective core area, the cross-section of the respective bending area and the selected material, which resilience and which installation thickness it should have, can be adjusted. Depending on the case of operation—as already addressed—a type of stopper can be realized with the respective core area of the wire.

Through the combination of different cross-sections complex geometries can be generated, which have the required spring-properties with regard to the application.

A further large advantage of such a sealing element consists in that fact, that the profile wire being used already has the needed final dimension and thus only a forming process and as required a joining process and if necessary a heat treatment still have to be carried out, in order to produce a media sealing element. Only under certain circumstances will a mechanical post-processing be necessary.

For the joining process also to be employed as required, both non-positive, positive as well as firmly bonded processes are conceivable. However, it can also be a matter of a combination, for example, of a positive and firmly bonded process (for example, a mechanical clamping with subsequent adhesive sealing of the joint).

It is of considerable importance, that through the selected geometry of the profile wire in connection with the suitable material its load-/deformation curve can be very strongly influenced. An ideal load deformation curve is represented by a horizontal line in the load deformation diagram. That means, at the beginning the deformation increases proportional to the increasing load. From a certain load level the load remains (virtually) the same, while the profile continues to be deformed. Not until the profile was almost completely deformed, does the load increase very strongly, with only minor deformation. At ultimately total compression only the load can be increased, and that can be brought about without a further deformation (however, plastic deformation is still conceivable). In this connection, the springback properties of the profile wire according to the present invention are of great importance. The springback constant is a measure for the ratio of elastic deformation to plastic deformation. The smaller the plastic deformation turns out during the loading of such a profile, the better the springback behavior is during its reduction of load. In the present case with the help of the geometry and the material selection a load deformation behavior can be achieved, which comes very close to the described ideal case. Thus it is possible:
to precisely define the installation point of such a sealing element,
to achieve a very high measure of springback behavior,
to minimize the required bolt force in the case of equal or better sealing function,
to minimize the distortions in the motor block or on other sealing flanges,
to counterbalance larger sealing-gap movements or oscillations.

The subject matter of the invention is depicted in the drawing with the help of an execution example and is described as follows:

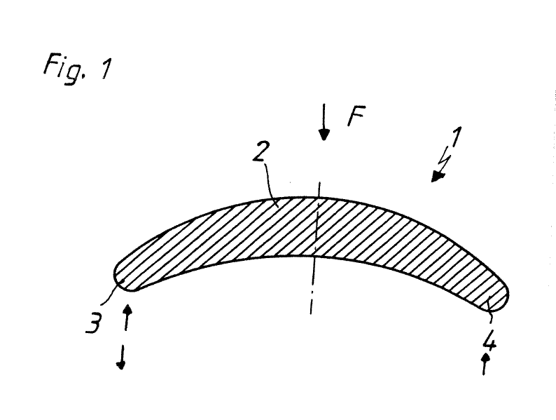

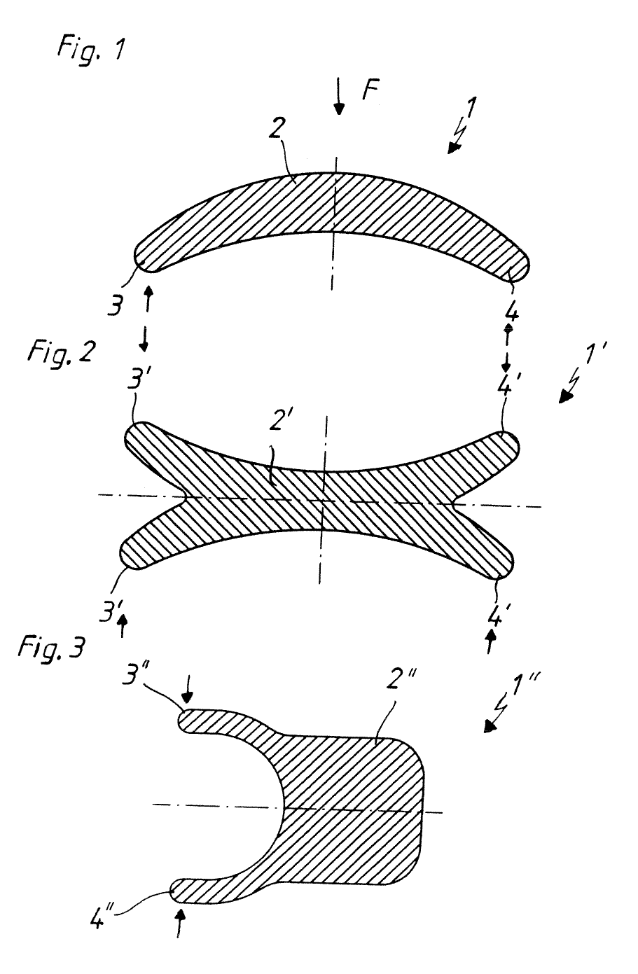

FIGS. 1 to 3 show different geometrical embodiments of a sealing element according to the present invention;

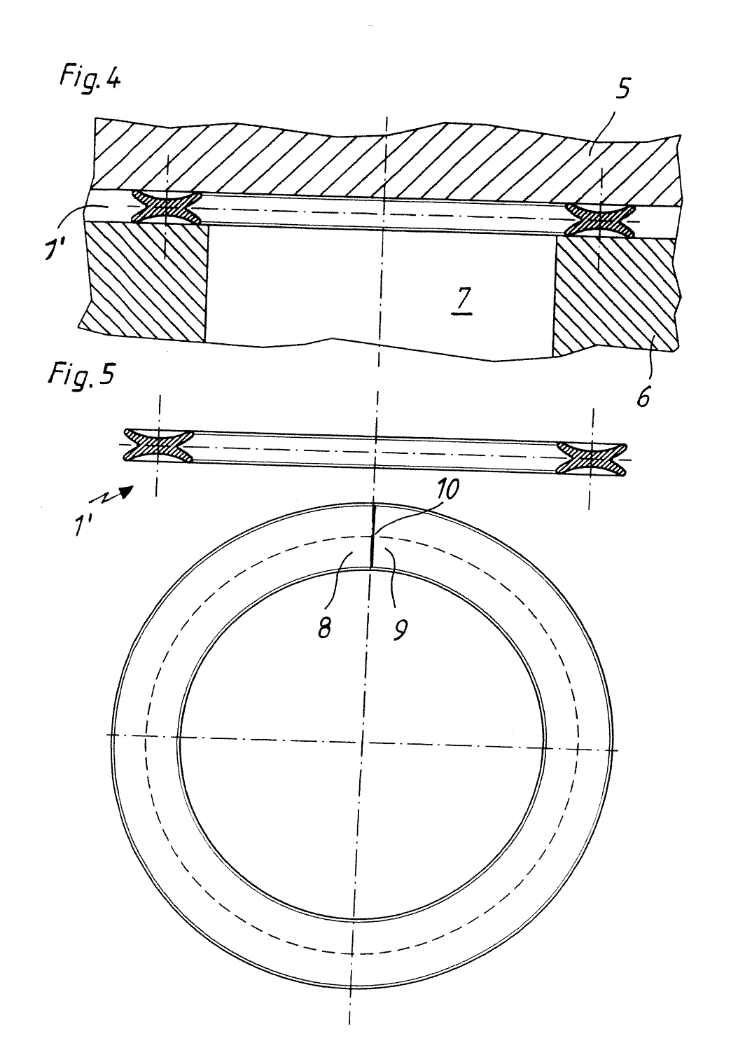

FIG. 4 shows a sealing element according to FIG. 2 in the preassembled state;

FIG. 5 shows a top view of the sealing element according to FIG. 4;

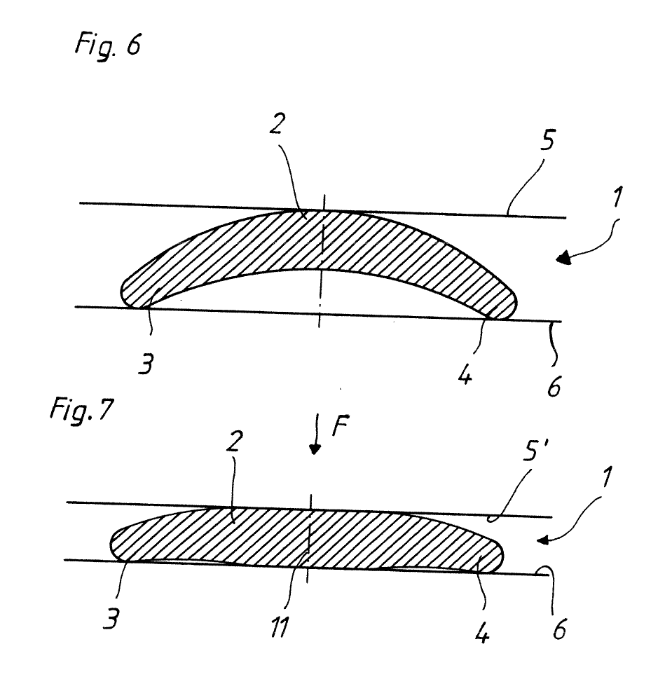

FIG. 6 shows a sealing element according to FIG. 1 in the preassembled state;

FIG. 7 shows a sealing element according to FIG. 6 in the state of its total compression;

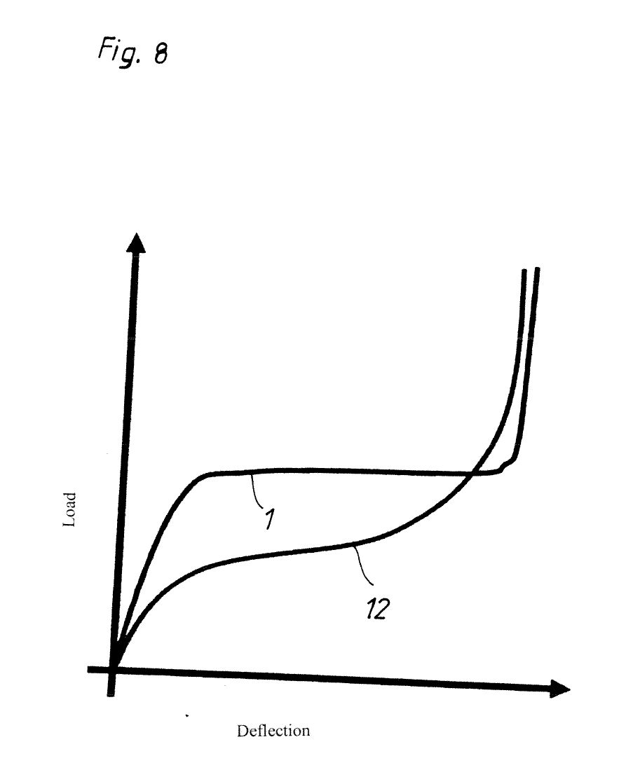

FIG. 8 shows a diagram of the load over the deflection of a sealing element according to the present invention in comparison to a conventional seam.

FIG. 1 shows a sealing element 1 in the form of a banana, which has defined elastic (spring-) properties.

FIGS. 2 and 3 show sealing elements 1′, 1″ in embodiments derived from FIG. 1.

The essential characteristic of all geometries according to FIGS. 1 to 3 is, that, on the one hand, the same have at least one core area 2,2′,2″, which under operating conditions (depending on the arrangement of the sealing element) can assume a stopper function and, on the other hand, includes at least one elastically bendable area 3,4,3′,4′,3″,4″ , which ensures the elastic sealing function under operating conditions.

The sealing element 1 according to FIG. 1, which has the banana-shaped geometry, has the maximum cross-section in its center. At both ends 3,4 the cross-section (uniform and irregular) tapers. That means, during loading F the respective elastic ends 3,4,3′,4′,3″,4″ bend, until during total compression only the core area 2,2′,2″ bears.

With the help of the subject matter of the invention a spring element (bending area 3,4,3′,4′,3″,4″) is thus combined with a stopper element (core area 2,2′,2″). The stopper height or the installation thickness (if only the profile wire—without other layers—is used) thus results from the largest cross-section or the largest cross-sections (if several sub-areas of the sealing element 1,1′,1″ are designed as core areas) of such a profile. The arrangement of the elastic areas 3,4,3′,4′,3″,4″ define the spring behavior and the sealing force of such a sealing element 1,1′,1″.

As already addressed, the sealing element 1,1′,1″ according to the present invention cannot only be arranged between the motor block and the cylinder head, but rather in addition are also used for sealing in the exhaust gas system. Due to different operating temperatures different materials are also used here.

If the sealing element 1,1′,1″ according to the present invention is to be used in the area of a cylinder-head gasket, the material has to be suitable for temperatures up to approx. 350° C.

If the sealing element 1, 1′, 1″ according to the present invention, is used, for example, as an exhaust gasket, it must be suitable for use at temperatures of >350° C., to the point of 1000° C.

In the following, only a few exemplary alloys are reproduced.

All data are in weight percentage.

A. Sealing Element for Use in the Area of a Cylinder-head Gasket

1. Austenitic Steel
C. max. 0.15%
Si max. 2.0%
Mn max. 9.5%
P max. 0.45%
S max. 0.04%
Cr 12.0 to 21.0%
Ni max. 16.0%
Mo max. 16.0%
Cu max. 4.0%
Fe remainder

2. Martensitic Steel
C 0.16 to 0.50%
Si max. 1.0%
Mn max. 1.5%
P max. 0.045%
S max. 0.04%
Cr 12.0 to 14.5%
Ni max. 0.75%
Mo max 1.0%
Fe remainder

3. Non-stainless Steel
C 0.50 to 1.30%
Si max. 3.0%
Mn max. 3.0%
P max. 0.035%
S max. 0.035%
Cr max. 2.0%
Fe remainder

B. Sealing Element for Operation in the Area of an Exhaust Flange Gasket

Depending on the temperature range (>350° C.) nickel-base alloys or nickel-base superalloys can be used. In the course of using such a sealing element according to the present invention it is a matter here essentially of nickel-chromium steels with a chromium portion between 17 and 23% and a nickel portion between 25 and 55%

All of the particulars regarding the elements are in weight percentage.

Regardless of whether they are designed symmetrically or asymmetrically, the bending areas of the sealing element 1,1′,1″ are provided with rounded end regions, in order to counter incisions in the respective counter surface.

FIG. 4 shows an indicated preassembled state. A cylinder head 5 is discernible as well as a motor block 6, which includes at least one combustion chamber 7. Here a sealing element I′ according to FIG. 2 should be used. The untensioned state is depicted, i.e., the sealing element 1′ was first positioned between the motor block 6 and the cylinder head 5.

FIG. 5 shows the sealing element 1′ according to FIG. 4. The ring-shaped designed, profiled sealing element 1′ is to have been generated in this example as an open profiled body, whose free end regions 8,9 were connected with each other by a suitable joining process, for example, a welding seam 10.

FIGS. 6 and 7 show the sealing element 1 according to FIG. 1, on the one hand, in a position, which corresponds to FIG. 4 (FIG. 6) and, on the other hand, in a state of total compression (FIG. 7). The core area 2 is discernible, as well as the bending areas 3,4. If the sealing element 1, should be braced, for example, between a cylinder head 5 and a motor block 6, the respective bending area 3,4 is deformed in a radial direction by applied outer axial force effect F, while under total compression the core area 2 is clamped between the sealing surfaces 5,6′ and thus a stopper area 11 is formed. Hence, a kind of three point support 3,4,11 is formed, in which the bending areas 3,4 remain elastically deformable and thus are also able to follow dynamic sealing oscillations.

FIG. 8 shows a diagram of the load applied over the deflection. Traditional beads 12 and the profile wire according to the present invention, for example, that according to FIG. 1, are compared.

An ideal load deformation curve is represented by a horizontal line in the load deformation diagram. That means, at the beginning, the deformation of the profile wire 1 increases proportional to the increasing load. From a certain load level the load remains essentially the same, while the profile continues to be deformed. Not until the profile was almost completely deformed, does the load increase very strongly, with only minor deformation. At total compression only the load can be increased.

1. Sealing element for the sealing of flange surfaces of internal combustion engines, comprising of at least one ring-shaped metallic profile body, wherein the profile body consists of a wire and at least one core area and has at least one bending area, in which the material thickness of the wire in the core area is larger than in the respective bending area.

2. Sealing element according to claim 1, wherein the wire comprises an open or closed ring.

3. Sealing element according to claim 1 wherein the radial wall thickness of the wire is profiled to correspond to the geometrical form of a banana.

4. Sealing element according to claim 1 wherein the wire has such a profile, that the radial ends, by forming a notch in each case, form two bending areas.

5. Sealing element according to claim 1 wherein the wire has such a profile, that a thickened core area is provided radially inwards or outwards and two bending areas are formed on the opposite ends of the cross-section.

6. Sealing element according to claim 1 wherein the respective bending areas in the initial state exceed the axial height of the core area.

7. Sealing element according to claim 1 wherein at least free radial end areas of the respective bending area rounded in form.

8. Sealing element according to claim 1 wherein the respective bending areas have identical material thicknesses .

9. Sealing element according to claim 1 wherein the respective bending areas have different material thicknesses.

10. Sealing element according to claim 1 wherein the wire is part of a cylinder-head gasket.

11. Sealing element according to claim 10 wherein the wire is provided for in the area of the respective combustion chamber passage opening of the cylinder-head gasket.

12. Sealing element according to claim 1 wherein the wire is provided for in the area of at least one media passage opening, such as a water or oil hole.

13. Sealing element according to claim 1 wherein the wire is part of a flat gasket, in particular, of an exhaust flange gasket.

14. Sealing element according to claim 1 wherein the wire is an individual sealing element in supply areas of combustion air and/or in discharge areas combustion gas.

15. Sealing element according to claim 1 wherein the wire is at least partially connected with parts of the cylinder-head gasket, or rather of the exhaust flange gasket.

16. Sealing element according to claim 12 wherein the wire is arranged radially movable at the respective opening.

17. Sealing element according to claim 1 wherein the wire is made of spring steel.

18. Sealing element according to claim 1 wherein the wire has a yield strength ≧600 MPa.

19. Sealing element according to claim 1 wherein the wire is made of an austenitic rust-free or low-rust material.

20. Sealing element according to claim 1 wherein the wire is made of a martensitic rust-free or low-rust material.

21. Sealing element according to claim 1 wherein the wire is made of a non-stainless steel.

22. Sealing element according to claim 1 wherein the wire is made of a nickel-base alloy.

23. Sealing element according to claim 1 wherein the wire is made of a nickel-base superalloy.

24. Sealing element according to claim 1 wherein the areas of sealing lines of the wire defining the sealing function are at least partially coated.
